(19) United States
(12) Patent Application Publication
(10) Pub. No.: US 2025/0004604 A1
(43) Pub. Date: Jan. 2, 2025

(54) ROBOTIC PROCESS AUTOMATION WITH ADAPTIVE EXECUTION OF SOFTWARE ROBOTS FOR OBSTRUCTION AVOIDANCE

(71) Applicant: Automation Anywhere, Inc., San Jose, CA (US)

(72) Inventors: Gaurangkumar PATEL, Fremont, CA (US); Murali Mohan PALLIKONDA, San Jose, CA (US); Ishan PANDYA, Baroda (IN)

(21) Appl. No.: 18/215,134

(22) Filed: Jun. 27, 2023

(51) Int. Cl. G06F 3/0481; G06F 9/451

(52) U.S. Cl. CPC G06F 3/0481; G06F 9/451

(57) ABSTRACT

Robotic process automation (RPA) systems with user interface obstruction processing for improved execution of software robots. The obstruction processing can detect and avoid unexpected user interface obstructions during execution of software robots. For example, while executing each of a plurality of actions of a software robot, a determination can be made whether a portion of a graphical user interface that is used by the associated action is being obstructed, and if so, processing can be performed to remove the obstruction. After removing any obstruction, the associated action of the software robot can be executed. Advantageously, software robots are able to execute in a resilient manner, whereby software robots are able to operate in a more reliable manner even when unexpected obstructions occur with graphical user interfaces.

### BACKGROUND OF THE INVENTION

Robotic process automation (RPA) systems enable automation of repetitive and manually intensive computer-based tasks. In an RPA system, computer software, namely a software robot (often referred to as a “bot”), may mimic the actions of a human user in order to perform various computer-based tasks. For instance, an RPA system can be used to interact with one or more software applications through user interfaces, as a human user would do. Therefore, RPA systems typically do not need to be integrated with existing software applications at a programming level, thereby eliminating the difficulties inherent to integration. Advantageously, RPA systems permit the automation of application level repetitive tasks via software robots that are coded to repeatedly and accurately perform the repetitive task.

Unfortunately, however, interacting with one or more software applications through user interfaces, as a human user would do, can be complicated when the user interfaces are altered due to unexpected obstructions that contaminate the user interfaces. Therefore, there is a need for improved approaches to continue execution of software robots in the presence of unexpected obstructions.

### SUMMARY

Robotic process automation (RPA) systems with user interface obstruction processing for improved execution of software robots are disclosed. The obstruction processing can detect and avoid unexpected user interface obstructions during execution of software robots. For example, while executing each of a plurality of actions of a software robot, a determination can be made whether a portion of a graphical user interface that is used by the associated action is being obstructed, and if so, processing can be performed to remove the obstruction. After removing any obstruction, the associated action of the software robot can be executed. Advantageously, software robots are able to execute in a resilient manner, whereby software robots are able to operate in a more reliable manner even when unexpected obstructions occur with graphical user interfaces.

The invention can be implemented in numerous ways, including as a method, system, device, apparatus (including computer readable medium and graphical user interface). Several embodiments of the invention are discussed below.

As a computer-implemented method of executing a bot with automated resiliency, one embodiment can, for example, include at least: identifying an action of the bot to be executed via a computing device having an associated display device, the action induces interaction with a particular portion of a graphical user interface (GUI) presented on the display device; determining whether the particular portion of the GUI is accessible to the bot; manipulating, when the particular portion of the GUI is determined to not be accessible to the bot, the manner by which at least a portion of the GUI is displayed on the display device so that the particular portion is accessible to the bot; and performing the action with respect to the particular portion of the GUI.

As a computer-implemented method of executing a bot with resiliency, one embodiment can, for example, include at least: identifying an action of the bot to be executed via a computing device having an associated display device, the action induces interaction with a particular portion of an application window presented on the display device; determining whether an unexpected pop-up window is present over the particular portion of the application window that the action of the bot is to interact with; modifying, when the it is determined that an unexpected pop-up window is present over the particular portion of the application window that the action of the bot is to interact with, presentation on the display device of the pop-up window or the application window so that the pop-up window is no longer present over the particular portion of the application window that the action of the bot is to interact with; and executing the action of the bot by inducing interaction with the particular portion of the application window presented on the display device.

As a computer-implemented method of executing a bot, one embodiment can, for example, include at least: identifying an action of the bot to be executed via a computing device having an associated display device; determining whether the action requires a graphical user interface (GUI) to be presented on the display device and accessible to the bot; identifying a portion of the GUI that the action requires be accessible to the bot; determining whether the portion of the GUI is presently accessible to the bot; manipulating, when the determining determines that the portion is not presently accessible to the bot, the manner by which the GUI is displayed on the display device so that the portion of the GUI becomes accessible to the bot; and subsequently performing the action with respect to the GUI.

As a non-transitory computer readable medium including at least computer program code tangibly stored thereon for executing a software robot, one embodiment can, for example, include at least: computer program code for identifying an action of the software robot to be executed via a computing device having an associated display device, the action induces interaction with a particular portion of a graphical user interface (GUI) presented on the display device; computer program code for determining whether the particular portion of the GUI is accessible to the software robot; computer program code for manipulating, when the particular portion of the GUI is determined to not be accessible to the software robot, the manner by which at least a portion of the GUI is displayed on the display device so that the particular portion is accessible to the software robot; and computer program code for performing the action with respect to the particular portion of the GUI.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of a robotic process automation system according to one embodiment.

FIG. 2 is a flow diagram of an adaptive execution process according to one embodiment.

FIG. 3 is a flow diagram of an adaptive execution process according to one embodiment.

FIG. 4 is a flow diagram of GUI modification processing according to one embodiment.

FIG. 5A illustrates a target window that displays a target control.

FIG. 5B illustrates the target window illustrated in FIG. 5A, in which a pointer is positioned over the target control.

FIG. 5C illustrates the target window illustrated in FIG. 5A, in which the target control is at least partially obstructed by an overlapping window.

FIG. 5D illustrates the target window illustrated in FIG. 5A, in which the target control is no longer obstructed by the overlapping window, according to one embodiment.

FIG. 5E illustrates the target window illustrated in FIG. 5A, in which the target control is no longer obstructed by the overlapping window, according to another embodiment.

FIG. 5F illustrates the target window illustrated in FIG. 5A, in which the target control is no longer obstructed by the overlapping window according to still another embodiment.

FIG. 6 is an exemplary screenshot of a software robot (e.g., bot) execution interface.

FIG. 7 illustrates exemplary pseudo code for execution of a software robot (e.g., bot) with obstruction handling according to one embodiment.

FIG. 8 is a block diagram of a robotic process automation system according to one embodiment.

FIG. 9 is a block diagram of a generalized runtime environment for bots in accordance with another embodiment of the robotic process automation system illustrated in FIG. 8.

FIG. 10 is yet another embodiment of the robotic process automation system of FIG. 8 configured to provide platform independent sets of task processing instructions for bots.

FIG. 11 is a block diagram illustrating details of one embodiment of the bot compiler illustrated in FIG. 10.

FIG. 12 is a block diagram of an exemplary computing environment for an implementation of a robotic process automation system.

### DETAILED DESCRIPTION OF CERTAIN EMBODIMENTS

Robotic process automation (RPA) systems with user interface obstruction processing for improved execution of software robots are disclosed. The obstruction processing can detect and avoid unexpected user interface obstructions during execution of software robots. For example, while executing each of a plurality of actions of a software robot, a determination can be made whether a portion of a graphical user interface that is used by the associated action is being obstructed, and if so, processing can be performed to remove the obstruction. After removing any obstruction, the associated action of the software robot can be executed. Advantageously, software robots are able to execute in a resilient manner, whereby software robots are able to operate in a more reliable manner even when unexpected obstructions occur with graphical user interfaces.

Generally speaking, RPA systems use computer software to emulate and integrate the actions of a human interacting within digital systems. In an enterprise environment, the RPA systems are often designed to execute a business process. In some cases, the RPA systems use artificial intelligence (AI) and/or other machine learning capabilities to handle high-volume, repeatable tasks that previously required humans to perform. The RPA systems also provide for creation, configuration, management, execution, monitoring, and performance of software automation processes.

A software automation process can also be referred to as a software robot, software agent, or a bot. A software automation process can interpret and execute tasks on your behalf. Software automation processes are particularly well suited for handling a lot of the repetitive tasks that humans perform every day. Software automation processes can perform a task or workflow they are tasked with once or 10,000 times and do it accurately every time. As one example, a software automation process can locate and read data in a document, email, file, or window. As another example, a software automation process can connect with one or more Enterprise Resource Planning (ERP), Customer Relations Management (CRM), core banking, and other business systems to distribute data where it needs to be in whatever format is necessary. As another example, a software automation process can perform data tasks, such as reformatting, extracting, balancing, error checking, moving, copying, etc. As another example, a software automation process can grab data desired from a webpage, application, screen, file, or other data source. As still another example, a software automation process can be trigger based on time or an event, and can serve to take files or data sets and move them to another location, whether it is to a customer, vendor, application, department or storage. These various capabilities can also be used in any combination. As an example of an integrated software automation process, the software automation process can start a task or workflow based on a trigger, such as a file being uploaded to an FTP system. The integrated software automation process can then download that file, scrape relevant data from it, upload the relevant data to a database, and then send an email to inform the recipient that the data has been successfully processed.

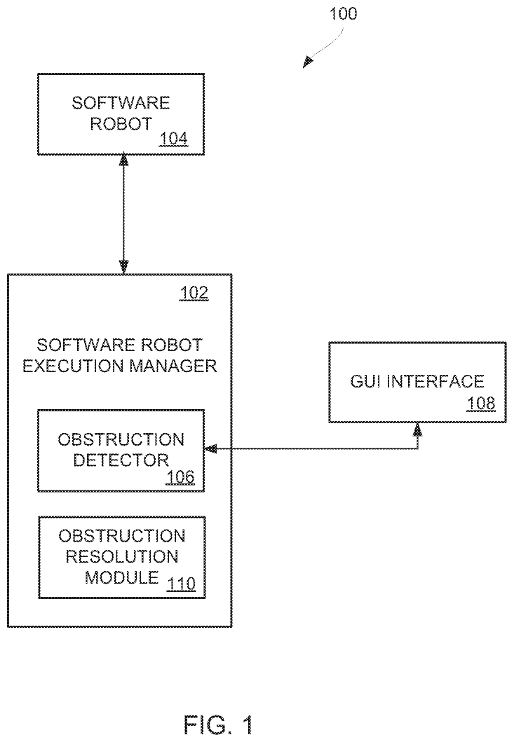

Embodiments of various aspects of the invention are discussed below with reference to FIGS. 1-12. However, those skilled in the art will readily appreciate that the detailed description given herein with respect to these figures is for explanatory purposes as the invention extends beyond these limited embodiments.

FIG. 1 is a block diagram of a robotic process automation system 100 according to one embodiment. The RPA system 100 includes a software robot execution manager 102. The software robot execution manager 102 can manage execution of a software robot 104. The software robot 104 is a computer program product that can automate actions carried out at a client-side computing device. These actions being automated, for example, can automate interactions (on behalf of a user) with one or more graphical user interfaces operating on a client-side computing device.

During the execution of the software robot 104, the software robot execution manager 102 can perform processing to adaptively execute the software robot 104. In this regard, during the execution of the software robot 104 on the client-side computing device, there can be unanticipated events that occur at the client side computing device, and these unanticipated events can inhibit proper execution of the software robot 104. However, through adaptive execution of the software robot 104, the software robot execution manager 102 can overcome such obstructions and allow proper execution of the software robot 104.

In one embodiment, the software robot execution manager 102 can include an obstruction detector 106. The obstruction detector 106 can evaluate whether the client-side computing device has an obstruction that would disrupt proper execution of the software robot 104. During execution of the software robot 104, unanticipated events can occur at the client-side computing device. For example, an unanticipated event can cause an obstruction to be present on a graphical user interface operating on the client-side computing device while the software robot 104 is being executed.

Is typical that the software robot 104 during its execution would interact with at least one graphical user interface 108 of at least one application program operating on the client-side computing device. However, other programs or events can occur at the client-side computing device that impact what is being presented on the graphical user interface 108. Hence, these other programs or events can lead to obstructions on the graphical user interface 108 that the software robot 104 needs to interact with. It is these obstructions that are detected by the obstruction detector 106.

The software robot execution manager 102 also includes an obstruction resolution module 110. The obstruction resolution module 110 can interact with the client-side computing device when the obstruction detector 106 has determined that there is an unanticipated obstruction that, if not removed, would interfere with the proper execution of the software robot 104. The obstruction resolution module 110 can perform actions to resolve the unanticipated obstruction. In one implementation, the obstruction resolution module 110 can programmatically manipulate the graphical user interface 108 in order to resolve the unanticipated obstruction. There are various approaches that can be utilized to resolve the unanticipated obstruction. As one example, the obstruction with respect to the graphical user interface 108 can be repositioned horizontally or vertically. Horizontal repositioning can move the obstruction to a different position on the graphical user interface 108 so that it no longer obstructs the portion of the graphical user interface 108 that the software robot 104 needs to interact with. The horizontal repositioning can move the obstruction left, right, up or down on the graphical user interface 108 so that it no longer obstructs the portion of the graphical user interface 108 that the software robot 104 needs to interact with. The obstruction can be an unexpected portion of the graphical user interface 108. For example, the obstruction can be a window on or within the graphical user interface 108. In one particular implementation, the horizontal repositioning might minimize the window that is obstructing. The vertical repositioning can move the obstruction to a rearward layer of the graphical user interface 108 so that it no longer obstructs the portion of the graphical user interface 108 that the software robot 104 needs to interact with because such portion becomes a top-most layer of the graphical user interface 108.

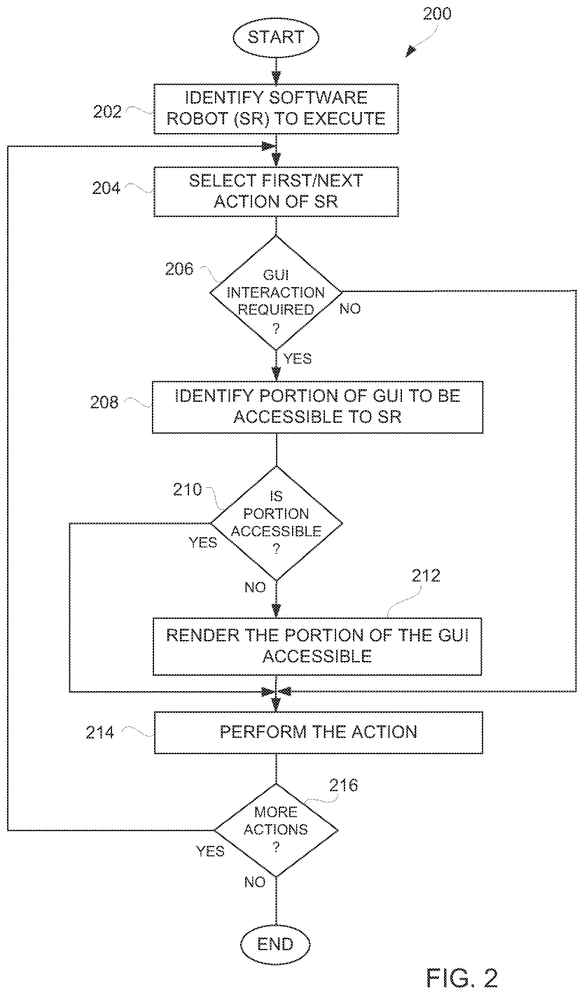

FIG. 2 is a flow diagram of an adaptive execution process 200 according to one embodiment. The adaptive execution process 200 can, for example, be performed by a software robot execution manager, such as the software robot execution manager 102 illustrated in FIG. 1.

The adaptive execution process 200 can identify 202 a software robot to execute. Next, a first action of the software robot can be selected 204. A decision 206 can then determine whether a graphical user interface (GUI) interaction is required when executing the action. Typically, a software robot performs numerous actions, and some of the actions require access to a graphical user interface. For example, actions that require GUI interaction can include a mouse event, an Optical Character Recognition (OCR), or a mimicked user interaction with the GUI. These types of actions can often be referred to as physical actions. A physical action with an object of a GUI can refer to an action performed using a mouse or other pointing device, such as clicking, dragging, or dropping an object. Some specific examples of physical actions include: Left Click, Right Click, Double Click, Set Text, and Append Text. Other more general examples of physical action can involve use of GUI controls, such as scroll bar, radio button, drop-down menu, text entry, and various others.

As other examples, actions that do not require GUI interaction can include soft actions, database interactions, or Application Programming Interface (API) calls. A soft action with an object of a GUI can refer to action performed, such as selecting an object or triggering a command without using GUI interaction.

When the decision 206 determines that a GUI interaction is required, then a portion of the GUI to be accessible to the software robot can be identified 208. The portion of the GUI being identified 208 can, for example, pertain to a point or area. Thereafter, a decision 210 can determine whether the portion of the GUI is accessible to the software robot. When the decision 210 determines that the portion of the GUI is not accessible to the software robot, then the portion of the GUI is rendered 212 accessible to the software robot. There are various different techniques that can be performed to render 212 the portion of the GUI available to the software robot. As one example, the portion of the GUI needed to be available to the software robot can be placed in an upper layer (e.g., top-most layer) of the GUI so it becomes accessible. At the same time, this will place the obstruction in a layer that is lower than the portion of the GUI that is needed for proper execution of the software robot execution. As another example, an obstruction over the portion of the GUI needed to be available to the software robot can be made invisible or transparent so it is effectively no longer an obstruction. As still another example, an obstruction over the portion of the GUI needed to be available to the software robot can be moved (e.g., repositioned) so it is no longer an obstruction. As an example of the obstruction being moved, the obstruction can be minimized such that its graphical size is reduced to a smaller size, or nearly or completely removed from a pertinent portion a display screen. For instance, the obstruction to the portion of the GUI needed to be available to the software robot can be a window, and the window can be minimized via use of a Microsoft Windows Operating System. Alternatively, when the decision 210 determines that the portion of the GUI is accessible to the software robot, the block 212 can be bypassed. Also, when the decision 206 determines that GUI interaction is not required during the execution of the action of the software robot, the adaptive execution process 200 can bypass blocks 208-212.

In any event, following the block 212 or its being bypassed, the adaptive execution process 200 can perform 214 the action of the software robot. After the action has been performed, a decision 216 can determine whether there are more actions to be executed by the software robot. When the decision 216 determines that there are more actions of the software robot to be executed, the adaptive execution process 200 can return to repeat the block 204 to select a next action of the software robot to be similarly processed at blocks 206-214. Alternatively, when the decision 216 determines that there are no more actions of the software robot to be executed, the adaptive execution process 200 can end.

In one embodiment, following the block 212, the adaptive execution process 200 can alternatively return to the block 210 to again determine 210 whether the portion of the GUI is accessible to the software robot. In the case in which there are more than one obstruction over the portion of the GUI to be accessible to the software robot, this embodiment can facilitate removal of a plurality of obstructions.

In one embodiment, the various different techniques that can be performed to render 212 the portion of the GUI available to the software robot can be implemented in a priority order. The highest priority techniques that is effective can be utilized. In one implementation, (i) a first priority can attempt to render the portion of the GUI available by placing the portion of the GUI needed to be available to the software robot to an upper layer (i.e., top-most layer) of the GUI so it becomes accessible; (ii) a second priority can attempt to render the portion of the GUI available by moving (e.g., minimize) the obstruction (e.g., obstructing window) so that it is no longer an obstruction; and (iii) a third priority can attempt to render the portion of the GUI available by making the obstruction (e.g., obstructing window) invisible or transparent so it is effectively no longer an obstruction. An example of an obstruction window is a pop-up window.

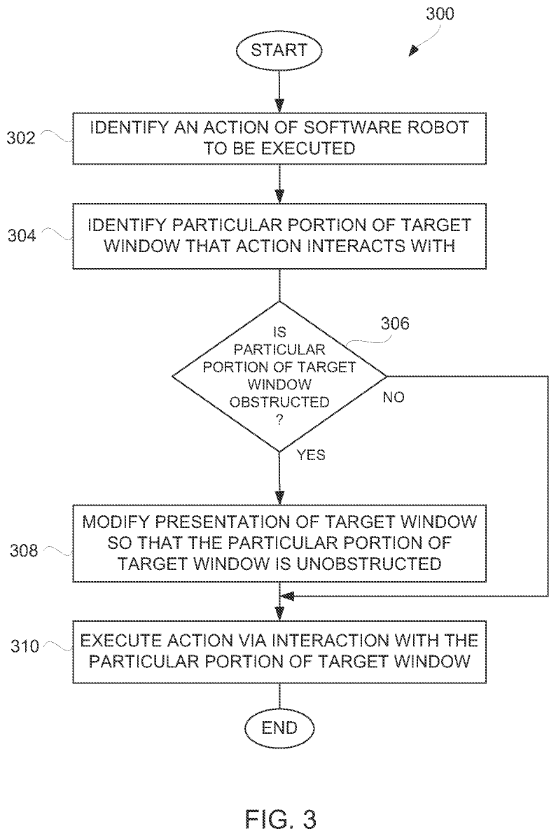

FIG. 3 is a flow diagram of an adaptive execution process 300 according to one embodiment. The adaptive execution process 300 can, for example, be performed by a software robot execution manager, such as the software robot execution manager 102 illustrated in FIG. 1.

The adaptive execution process 300 can initially identify 302 an action of the software robot to be executed. Next, a particular portion of a target window that the action interacts with can be identified 304. The particular portion (also referred to as particular region) can be a singular point (e.g., x, y position) or a particular area. The particular area can be defined by a plurality of particular points that are within the particular portion.

Next, a decision 306 can determine whether the particular portion of the target window is obstructed. For example, the particular portion of the target window can be obstructed by an unexpected window, such as pop-up window. Some examples of pop-up windows include pop-up windows for software updates, new message notifications, and various others. When the decision 306 determines that the particular portion of the target window is obstructed, presentation of the target window is modified 308 so that the particular portion of the target window is no longer obstructed. On the other hand, when the decision 306 determines that the particular portion of the target window is not obstructed, the block 308 can be bypassed since processing is not needed to remove an obstruction. In any event, following the block 308, or its being bypassed, the adaptive execution process 300 can execute 310 the action via interaction with the particular portion of the target window. Following the execution 310 of the action, the adaptive execution process 300 can end. However, although the adaptive execution process 300 is described with respect to execution of a single action with respect to a software robot, the software robot normally includes a substantial plurality of actions, and execution of each of the actions can be processed in a similar manner.

In one embodiment, when a software robot is operating on a client-side computing device operating a Window's operating system, the operating system can include Dynamically Linked Libraries (DLLs), such as those within user32.dll, that can be utilized in executing the software robot so that the portion of a GUI that the software robot seeks to interact with is available. As one example, to set a target application window to the top-most window, a SetWindowPos API can be used. As another example, to minimize an obstructing window, a ShowWindow API can be used. As still another example, to render an obstructing window transparent, first, a SetWindowLong API can be used to mark the obstructing window as a layered window; and second, a SetLayeredWindowAttributes API can be used to set the obstructing window's opacity value (e.g., opacity value=0, for transparent, and 255, for opaque).

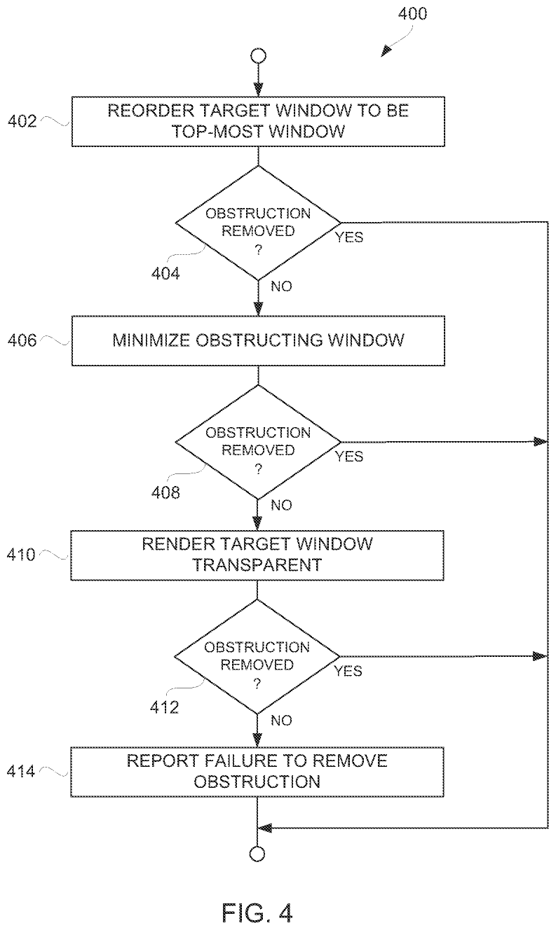

FIG. 4 is a flow diagram of GUI modification processing 400 according to one embodiment. The GUI modification processing 400 details one embodiment of processing to implement one or more of a series of actions to remove one or more obstructions. The GUI modification processing 400 can pertain to processing that can be performed, in one embodiment, for at least a portion of processing to (i) render 212 the portion of a GUI accessible to the software robot (FIG. 2), or (ii) to modify 308 presentation so that a target window is not obstructed (FIG. 3). In this embodiment, for ease of discussion, the portion of a GUI that needs to be accessible is referred to as a target window, and the obstruction is referred to as an obstructing window.

The GUI modification processing 400 can reorder 402 a target window of the GUI to be a top-most window of the GUI. A decision 404 can then determine whether the target window is now accessible after the reordering 402. If the decision 404 determines that the target window is still obstructed, then the GUI modification processing 400 can minimize 406 the obstructing window. A decision 408 can then determine whether the target window is now accessible after the minimizing 406. If the decision 408 determines that the target window is still obstructed, then the GUI modification processing 400 renders 410 the obstructing window transparent. Next, a decision 412 then determines whether the target window is now accessible after the rendering 410. If the decision 412 determines that the target window is still obstructed, then the GUI modification processing 400 can report 414 its failure to remove the obstructing window. However, following any of the decisions 404, 408 and 412, if it is determined that the target window is accessible and no longer obstructed, the GUI modification processing 400 can end.

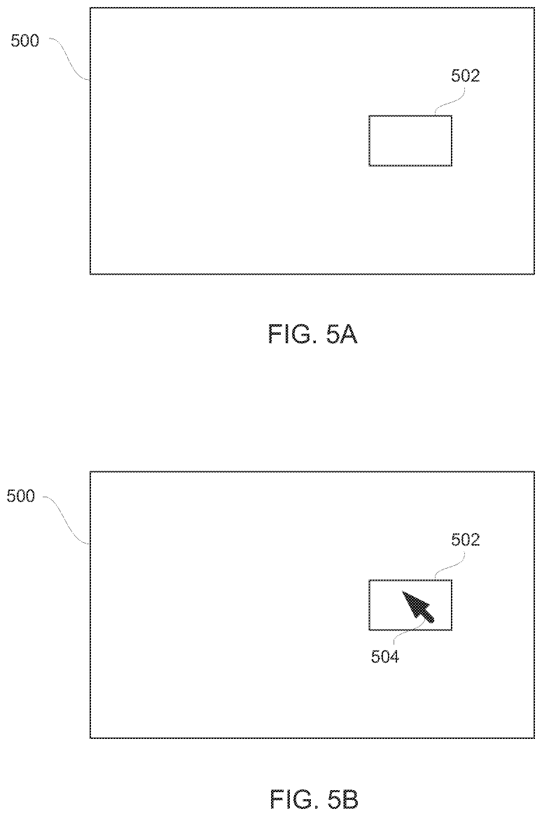

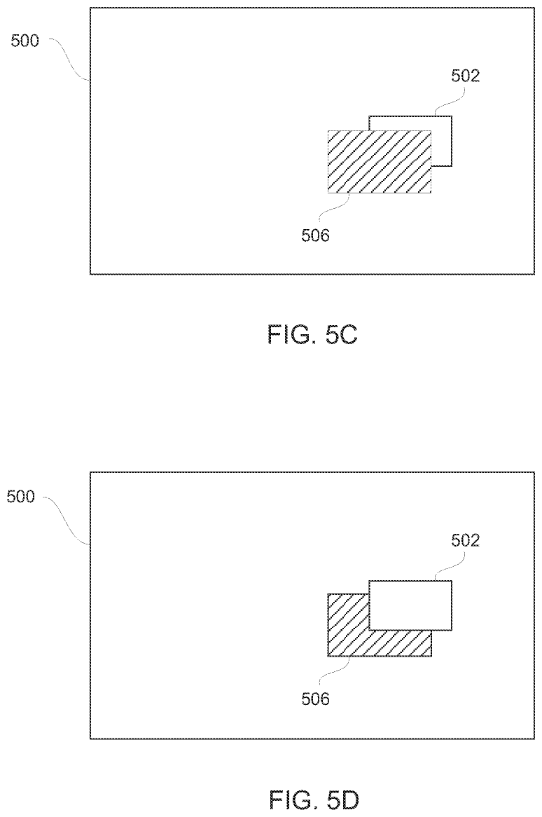

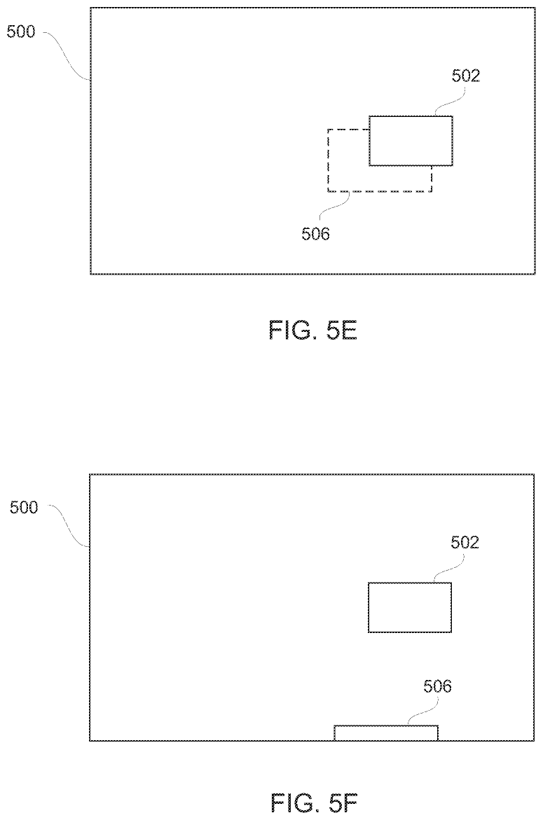

FIG. 5A illustrates a target window 500 that displays a target control 502. The target window 500 can be considered a portion of a graphical user interface. The target control 502 is, for example, a user interactable control object that can be interacted with as part of the target window 500.

FIG. 5B illustrates the target window 500 illustrated in FIG. 5A, in which a pointer 504 is positioned over the target control 502. Typically, when an interaction is to occur with respect to the target control 502, the pointer 504 is manipulated (e.g., with a mouse, touch surface, etc.) to reside over the target control 502. In the case of the execution of a software robot, the software robot can cause a pointer, such as the pointer 504, to be positioned over the target control 502, and once so positioned, the software robot can cause the target control 502 to be selected or invoked.

FIG. 5C illustrates the target window 500 illustrated in FIG. 5A, in which the target control 502 is at least partially obstructed by an overlapping window 506. In this example, the overlapping window 506 substantially, but not completely, overlaps over the top of the target control 502. As depicted in FIG. 5C, the target control 502 is substantially obstructed by the overlapping window 506. The overlapping window 506 need not be a window but can, more generally, refer to a type of graphical user interface element, such as a text box, button, pop-up box, drop-down menu, selector, and various others.

FIG. 5D illustrates the target window 500 illustrated in FIG. 5A, in which the target control 502 is no longer obstructed by the overlapping window 506, according to one embodiment. As compared with FIG. 5C, the overlapping window 506 as shown in FIG. 5D is now repositioned to be vertically behind the target control 502. As a result, the overlapping window 506 is no longer obstructing the target control 502. In one implementation, the target control 502 is repositioned to be at a top level such that the overlapping window 506 is positioned behind the target control 502.

FIG. 5E illustrates the target window 500 illustrated in FIG. 5A, in which the target control 502 is no longer obstructed by the overlapping window 506, according to another embodiment. As compared with FIG. 5C, the overlapping window 506 as shown in FIG. 5E is modified to be a transparent window. As a result, the overlapping window 506, upon being converted to a transparent window, is no longer obstructing the target window 502.

FIG. 5F illustrates the target window 500 illustrated in FIG. 5A, in which the target control 502 is no longer obstructed by the overlapping window 506 according to still another embodiment. As compared with FIG. 5C, the overlapping window 506 has been physically repositioned such that it no longer obstructs the target control 502. In one implementation, the repositioning of the overlapping window 506 can be achieved by minimizing the overlapping window 506. In other implementations, the repositioning of the overlapping window 506 can be achieved by repositioning other than through minimization.

In one embodiment, a software robot can implement one or more of a series of actions to remove one or more obstructions to a GUI that the software robot needs to access.

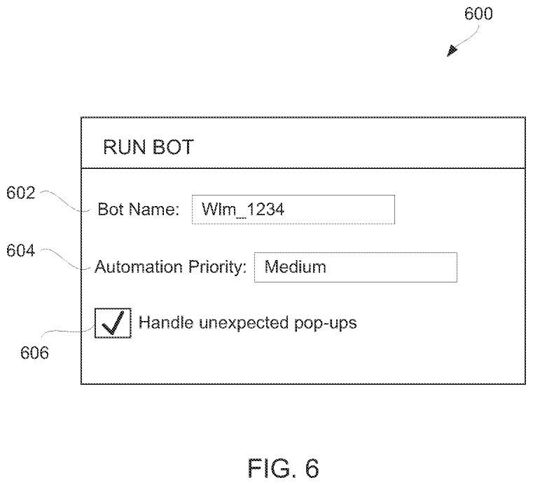

FIG. 6 is an exemplary screenshot of a software robot (e.g., bot) execution interface 600. The software robot execution interface 600 is used to configure when and/or how the software robot is to execute on a client-side computing device. The software robot execution interface 600 includes a name field 602 in which a name of the software robot to be run (i.e., executed) can be identified. The software robot execution interface 600 can also include a priority field 604 where a priority for the execution can be specified. As shown, the priority field 604 specifies a medium priority. Alternatively, the priority field could specify a low or high priority. Still further, the software robot execution interface 600 can include an enable/disable control 606. The enable/disable control 606 allows a user to enable or disable handling of unexpected pop-up obstruction when executing the identified software robot (e.g., bot) in accordance with any of the embodiment discussed herein.

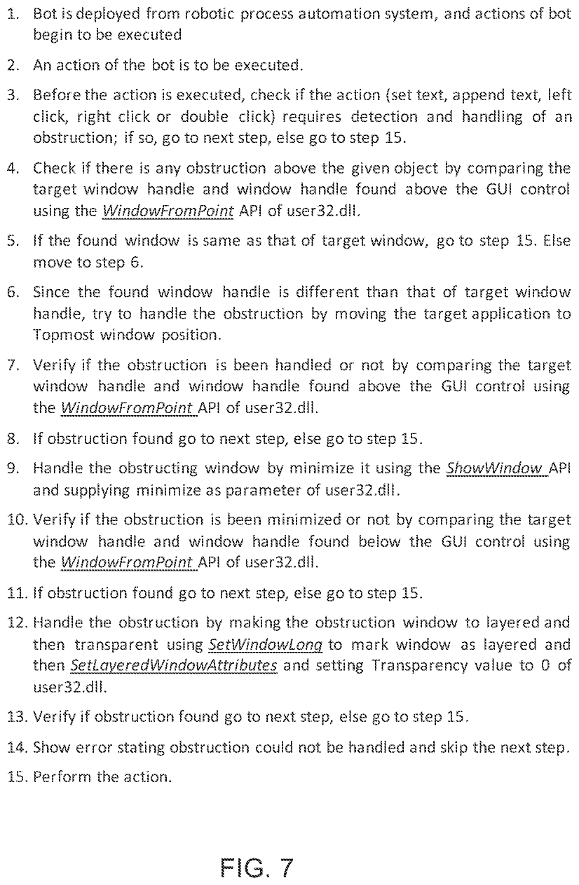

FIG. 7 illustrates exemplary pseudo code for execution of a software robot (e.g., bot) with obstruction handling according to one embodiment. The exemplary pseudo code is executing on a Windows-based platform, with each window being distinctly identified by a window handle.

The various aspects disclosed herein can be utilized with or by robotic process automation systems. Exemplary robotic process automation systems and operations thereof are detailed below.

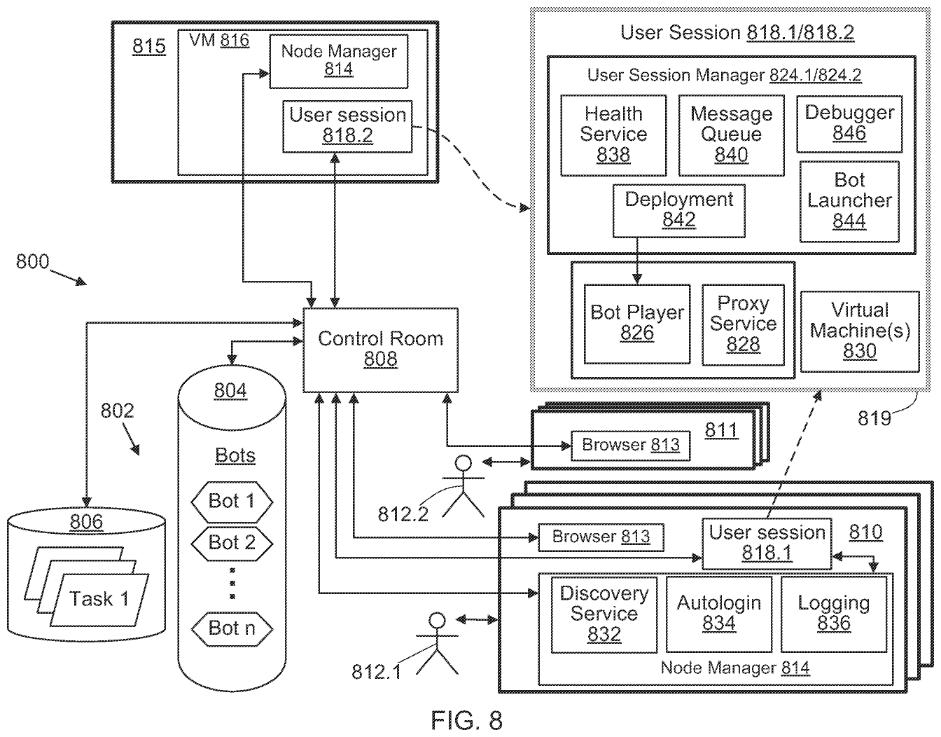

FIG. 8 is a block diagram of a robotic process automation (RPA) system 800 according to one embodiment. The RPA system 800 includes data storage 802. The data storage 802 can store a plurality of software robots 804, also referred to as bots (e.g., Bot 1, Bot 2, . . . , Bot n). The software robots 804 can be operable to interact at a user level with one or more user level application programs (not shown). As used herein, the term “bot” is generally synonymous with the term software robot. In certain contexts, as will be apparent to those skilled in the art in view of the present disclosure, the term “bot runner” refers to a device (virtual or physical), having the necessary software capability (such as bot player 826), on which a bot will execute or is executing. The data storage 802 can also stores a plurality of work items 806. Each work item 806 can pertain to processing executed by one or more of the software robots 804.

The RPA system 800 can also include a control room 808. The control room 808 is operatively coupled to the data storage 802 and is configured to execute instructions that, when executed, cause the RPA system 800 to respond to a request from a client device 810 that is issued by a user 812.1. The control room 808 can act as a server to provide to the client device 810 the capability to perform an automation task to process a work item from the plurality of work items 806. The RPA system 800 is able to support multiple client devices 810 concurrently, each of which will have one or more corresponding user session(s) 818, which provides a context. The context can, for example, include security, permissions, audit trails, etc. to define the permissions and roles for bots operating under the user session 818. For example, a bot executing under a user session, cannot access any files or use any applications that the user, under whose credentials the bot is operating, does not have permission to do so. This prevents any inadvertent or malicious acts from a bot under which bot 804 executes.

The control room 808 can provide, to the client device 810, software code to implement a node manager 814. The node manager 814 executes on the client device 810 and provides a user 812 a visual interface via browser 813 to view progress of and to control execution of automation tasks. It should be noted that the node manager 814 can be provided to the client device 810 on demand, when required by the client device 810, to execute a desired automation task. In one embodiment, the node manager 814 may remain on the client device 810 after completion of the requested automation task to avoid the need to download it again. In another embodiment, the node manager 814 may be deleted from the client device 810 after completion of the requested automation task. The node manager 814 can also maintain a connection to the control room 808 to inform the control room 808 that device 810 is available for service by the control room 808, irrespective of whether a live user session 818 exists. When executing a bot 804, the node manager 814 can impersonate the user 812 by employing credentials associated with the user 812.

The control room 808 initiates, on the client device 810, a user session 818 (seen as a specific instantiation 818.1) to perform the automation task. The control room 808 retrieves the set of task processing instructions 804 that correspond to the work item 806. The task processing instructions 804 that correspond to the work item 806 can execute under control of the user session 818.1, on the client device 810. The node manager 814 can provide update data indicative of status of processing of the work item to the control room 808. The control room 808 can terminate the user session 818.1 upon completion of processing of the work item 806. The user session 818.1 is shown in further detail at 819, where an instance 824.1 of user session manager 824 is seen along with a bot player 826, proxy service 828, and one or more virtual machine(s) 830, such as a virtual machine that runs Java® or Python®. The user session manager 824 provides a generic user session context within which a bot 804 executes.

The bots 804 execute on a player, via a computing device, to perform the functions encoded by the bot. Some or all of the bots 804 may in certain embodiments be located remotely from the control room 808. Moreover, the devices 810 and 811, which may be conventional computing devices, such as for example, personal computers, server computers, laptops, tablets and other portable computing devices, may also be located remotely from the control room 808. The devices 810 and 811 may also take the form of virtual computing devices. The bots 804 and the work items 806 are shown in separate containers for purposes of illustration but they may be stored in separate or the same device(s), or across multiple devices. The control room 808 can perform user management functions, source control of the bots 804, along with providing a dashboard that provides analytics and results of the bots 804, performs license management of software required by the bots 804 and manages overall execution and management of scripts, clients, roles, credentials, security, etc. The major functions performed by the control room 808 can include: (i) a dashboard that provides a summary of registered/active users, tasks status, repository details, number of clients connected, number of scripts passed or failed recently, tasks that are scheduled to be executed and those that are in progress; (ii) user/role management—permits creation of different roles, such as bot creator, bot runner, admin, and custom roles, and activation, deactivation and modification of roles; (iii) repository management—to manage all scripts, tasks, workflows and reports etc.; (iv) operations management—permits checking status of tasks in progress and history of all tasks, and permits the administrator to stop/start execution of bots currently executing; (v) audit trail—logs creation of all actions performed in the control room; (vi) task scheduler—permits scheduling tasks which need to be executed on different clients at any particular time; (vii) credential management—permits password management; and (viii) security: management—permits rights management for all user roles. The control room 808 is shown generally for simplicity of explanation. Multiple instances of the control room 808 may be employed where large numbers of bots are deployed to provide for scalability of the RPA system 800.

In the event that a device, such as device 811 (e.g., operated by user 812.2) does not satisfy the minimum processing capability to run a node manager 814, the control room 808 can make use of another device, such as device 815, that has the requisite capability. In such case, a node manager 814 within a Virtual Machine (VM), seen as VM 816, can be resident on the device 815. The node manager 814 operating on the device 815 can communicate with browser 813 on device 811. This approach permits RPA system 800 to operate with devices that may have lower processing capability, such as older laptops, desktops, and portable/mobile devices such as tablets and mobile phones. In certain embodiments the browser 813 may take the form of a mobile application stored on the device 811. The control room 808 can establish a user session 818.2 for the user 812.2 while interacting with the control room 808 and the corresponding user session 818.2 operates as described above for user session 818.1 with user session manager 824 operating on device 810 as discussed above.

In certain embodiments, the user session manager 824 provides five functions. First is a health service 838 that maintains and provides a detailed logging of bot execution including monitoring memory and CPU usage by the bot and other parameters such as number of file handles employed. The bots 804 can employ the health service 838 as a resource to pass logging information to the control room 808. Execution of the bot is separately monitored by the user session manager 824 to track memory, CPU, and other system information. The second function provided by the user session manager 824 is a message queue 840 for exchange of data between bots executed within the same user session 818. The third function is a deployment service (also referred to as a deployment module) 842 that connects to the control room 808 to request execution of a requested bot 804. The deployment service 842 can also ensure that the environment is ready for bot execution, such as by making available dependent libraries. The fourth function is a bot launcher 844 which can read metadata associated with a requested bot 804 and launch an appropriate container and begin execution of the requested bot. The fifth function is a debugger service 846 that can be used to debug bot code.

The bot player 826 can execute, or play back, a sequence of instructions encoded in a bot. The sequence of instructions can, for example, be captured by way of a recorder when a human performs those actions, or alternatively the instructions are explicitly coded into the bot. These instructions enable the bot player 826, to perform the same actions as a human would do in their absence. In one implementation, the instructions can compose of a command (action) followed by set of parameters, for example: Open Browser is a command, and a URL would be the parameter for it to launch a web resource. Proxy service 828 can enable integration of external software or applications with the bot to provide specialized services. For example, an externally hosted artificial intelligence system could enable the bot to understand the meaning of a “sentence.”

The user 812.1 can interact with node manager 814 via a conventional browser 813 which employs the node manager 814 to communicate with the control room 808. When the user 812.1 logs in from the client device 810 to the control room 808 for the first time, the user 812.1 can be prompted to download and install the node manager 814 on the device 810, if one is not already present. The node manager 814 can establish a web socket connection to the user session manager 824, deployed by the control room 808 that lets the user 812.1 subsequently create, edit, and deploy the bots 804.

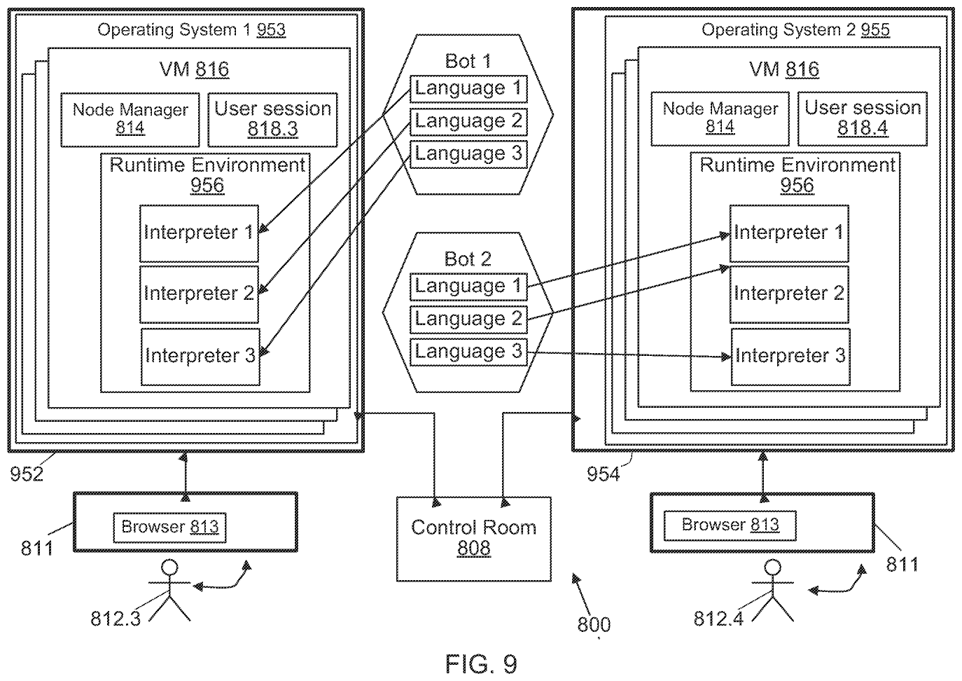

FIG. 9 is a block diagram of a generalized runtime environment for bots 804 in accordance with another embodiment of the RPA system 800 illustrated in FIG. 8. This flexible runtime environment advantageously permits extensibility of the platform to enable use of various languages in encoding bots. In the embodiment of FIG. 9, RPA system 800 generally operates in the manner described in connection with FIG. 8, except that in the embodiment of FIG. 9, some or all of the user sessions 818 execute within a virtual machine 816. This permits the bots 804 to operate on an RPA system 800 that runs on an operating system different from an operating system on which a bot 804 may have been developed. For example, if a bot 804 is developed on the Windows® operating system, the platform agnostic embodiment shown in FIG. 9 permits the bot 804 to be executed on a device 952 or 954 executing an operating system 953 or 955 different than Windows®, such as, for example, Linux. In one embodiment, the VM 816 takes the form of a Java Virtual Machine (JVM) as provided by Oracle Corporation. As will be understood by those skilled in the art in view of the present disclosure, a JVM enables a computer to run Java® programs as well as programs written in other languages that are also compiled to Java® bytecode.

In the embodiment shown in FIG. 9, multiple devices 952 can execute operating system 1, 953, which may, for example, be a Windows® operating system. Multiple devices 954 can execute operating system 2, 955, which may, for example, be a Linux® operating system. For simplicity of explanation, two different operating systems are shown, by way of example and additional operating systems such as the macOS®, or other operating systems may also be employed on devices 952, 954 or other devices. Each device 952, 954 has installed therein one or more VM's 816, each of which can execute its own operating system (not shown), which may be the same or different than the host operating system 953/955. Each VM 816 has installed, either in advance, or on demand from control room 808, a node manager 814. The embodiment illustrated in FIG. 9 differs from the embodiment shown in FIG. 8 in that the devices 952 and 954 have installed thereon one or more VMs 816 as described above, with each VM 816 having an operating system installed that may or may not be compatible with an operating system required by an automation task. Moreover, each VM has installed thereon a runtime environment 956, each of which has installed thereon one or more interpreters (shown as interpreter 1, interpreter 2, interpreter 3). Three interpreters are shown by way of example but any run time environment 956 may, at any given time, have installed thereupon less than or more than three different interpreters. Each interpreter 956 is specifically encoded to interpret instructions encoded in a particular programming language. For example, interpreter 1 may be encoded to interpret software programs encoded in the Java® programming language, seen in FIG. 9 as language 1 in Bot 1 and Bot 2. Interpreter 2 may be encoded to interpret software programs encoded in the Python® programming language, seen in FIG. 9 as language 2 in Bot 1 and Bot 2, and interpreter 3 may be encoded to interpret software programs encoded in the R programming language, seen in FIG. 9 as language 3 in Bot 1 and Bot 2.

Turning to the bots Bot 1 and Bot 2, each bot may contain instructions encoded in one or more programming languages. In the example shown in FIG. 9, each bot can contain instructions in three different programming languages, for example, Java®, Python® and R. This is for purposes of explanation and the embodiment of FIG. 9 may be able to create and execute bots encoded in more or less than three programming languages. The VMs 816 and the runtime environments 956 permit execution of bots encoded in multiple languages, thereby permitting greater flexibility in encoding bots. Moreover, the VMs 816 permit greater flexibility in bot execution. For example, a bot that is encoded with commands that are specific to an operating system, for example, open a file, or that requires an application that runs on a particular operating system, for example, Excel® on Windows®, can be deployed with much greater flexibility. In such a situation, the control room 808 will select a device with a VM 816 that has the Windows® operating system and the Excel® application installed thereon. Licensing fees can also be reduced by serially using a particular device with the required licensed operating system and application(s), instead of having multiple devices with such an operating system and applications, which may be unused for large periods of time.

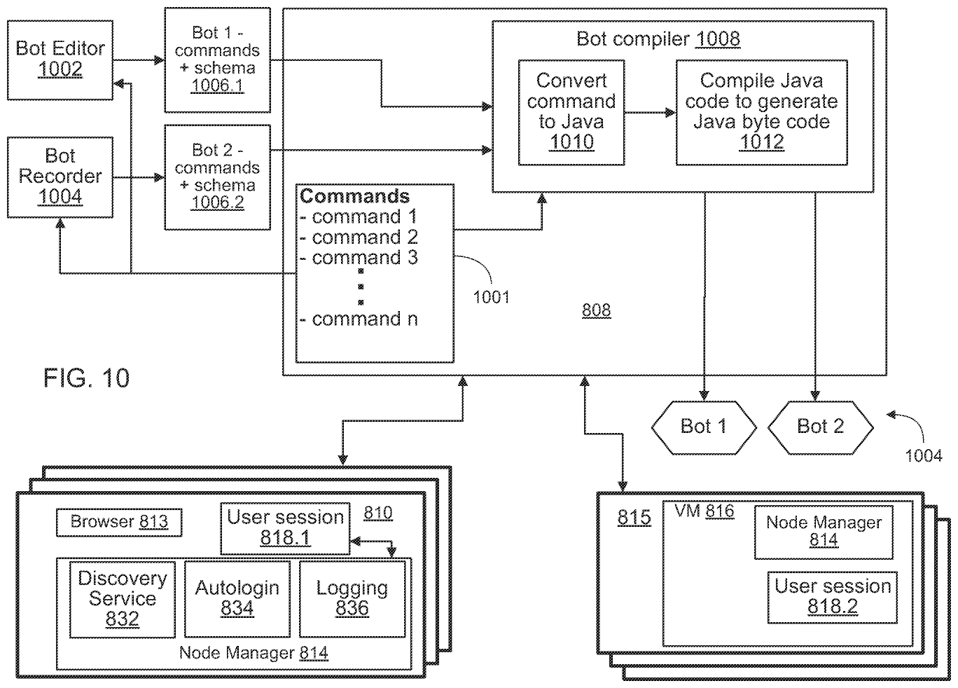

FIG. 10 illustrates a block diagram of yet another embodiment of the RPA system 800 of FIG. 8 configured to provide platform independent sets of task processing instructions for bots 804. Two bots 804, bot 1 and bot 2 are shown in FIG. 10. Each of bots 1 and 2 are formed from one or more commands 1001, each of which specifies a user level operation with a specified application program, or a user level operation provided by an operating system. Sets of commands 1006.1 and 1006.2 may be generated by bot editor 1002 and bot recorder 1004, respectively, to define sequences of application-level operations that are normally performed by a human user. The bot editor 1002 may be configured to combine sequences of commands 1001 via an editor. The bot recorder 1004 may be configured to record application-level operations performed by a user and to convert the operations performed by the user to commands 1001. The sets of commands 1006.1 and 1006.2 generated by the editor 1002 and the recorder 1004 can include command(s) and schema for the command(s), where the schema defines the format of the command(s). The format of a command can, such as, includes the input(s) expected by the command and their format. For example, a command to open a URL might include the URL, a user login, and a password to login to an application resident at the designated URL.

The control room 808 operates to compile, via compiler 1008, the sets of commands generated by the editor 1002 or the recorder 1004 into platform independent executables, each of which is also referred to herein as a bot JAR (Java ARchive) that perform application-level operations captured by the bot editor 1002 and the bot recorder 1004. In the embodiment illustrated in FIG. 10, the set of commands 1006, representing a bot file, can be captured in a JSON (JavaScript Object Notation) format which is a lightweight data-interchange text-based format. JSON is based on a subset of the JavaScript Programming Language Standard ECMA-262 3rd Edition—December 1999. JSON is built on two structures: (i) a collection of name/value pairs; in various languages, this is realized as an object, record, struct, dictionary, hash table, keyed list, or associative array, (ii) an ordered list of values which, in most languages, is realized as an array, vector, list, or sequence. Bots 1 and 2 may be executed on devices 810 and/or 815 to perform the encoded application-level operations that are normally performed by a human user.

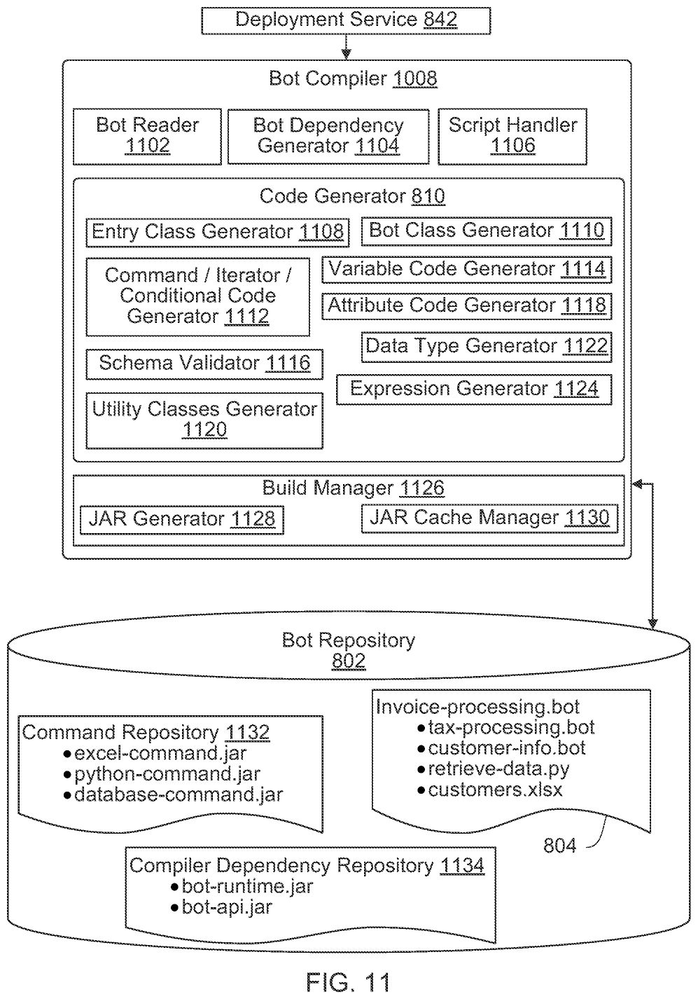

FIG. 11 is a block diagram illustrating details of one embodiment of the bot compiler 1008 illustrated in FIG. 10. The bot compiler 1008 accesses one or more of the bots 804 from the data storage 802, which can serve as bot repository, along with commands 1001 that are contained in a command repository 1132. The bot compiler 808 can also access compiler dependency repository 1134. The bot compiler 808 can operate to convert each command 1001 via code generator module 1010 to an operating system independent format, such as a Java command. The bot compiler 808 then compiles each operating system independent format command into byte code, such as Java byte code, to create a bot JAR. The convert command to Java module 1010 is shown in further detail in in FIG. 11 by JAR generator 1128 of a build manager 1126. The compiling to generate Java byte code module 1012 can be provided by the JAR generator 1128. In one embodiment, a conventional Java compiler, such as javac from Oracle Corporation, may be employed to generate the bot JAR (artifacts). As will be appreciated by those skilled in the art, an artifact in a Java environment includes compiled code along with other dependencies and resources required by the compiled code. Such dependencies can include libraries specified in the code and other artifacts. Resources can include web pages, images, descriptor files, other files, directories and archives.

As noted in connection with FIG. 10, deployment service 842 can be responsible to trigger the process of bot compilation and then once a bot has compiled successfully, to execute the resulting bot JAR on selected devices 810 and/or 815. The bot compiler 1008 can comprises a number of functional modules that, when combined, generate a bot 804 in a JAR format. A bot reader 1102 loads a bot file into memory with class representation. The bot reader 1102 takes as input a bot file and generates an in-memory bot structure. A bot dependency generator 1104 identifies and creates a dependency graph for a given bot. It includes any child bot, resource file like script, and document or image used while creating a bot. The bot dependency generator 1104 takes, as input, the output of the bot reader 1102 and provides, as output, a list of direct and transitive bot dependencies. A script handler 1106 handles script execution by injecting a contract into a user script file. The script handler 1106 registers an external script in manifest and bundles the script as a resource in an output JAR. The script handler 1106 takes, as input, the output of the bot reader 1102 and provides, as output, a list of function pointers to execute different types of identified scripts like Python, Java, VB scripts.

An entry class generator 1108 can create a Java class with an entry method, to permit bot execution to be started from that point. For example, the entry class generator 1108 takes, as an input, a parent bot name, such “Invoice-processing.bot” and generates a Java class having a contract method with a predefined signature. A bot class generator 1110 can generate a bot class and orders command code in sequence of execution. The bot class generator 1110 can take, as input, an in-memory bot structure and generates, as output, a Java class in a predefined structure. A Command/Iterator/Conditional Code Generator 1112 wires up a command class with singleton object creation, manages nested command linking, iterator (loop) generation, and conditional (If/Else If/Else) construct generation. The Command/Iterator/Conditional Code Generator 1112 can take, as input, an in-memory bot structure in JSON format and generates Java code within the bot class. A variable code generator 1114 generates code for user defined variables in the bot, maps bot level data types to Java language compatible types, and assigns initial values provided by user. The variable code generator 1114 takes, as input, an in-memory bot structure and generates Java code within the bot class. A schema validator 1116 can validate user inputs based on command schema and includes syntax and semantic checks on user provided values. The schema validator 1116 can take, as input, an in-memory bot structure and generates validation errors that it detects. The attribute code generator 1118 can generate attribute code, handles the nested nature of attributes, and transforms bot value types to Java language compatible types. The attribute code generator 1118 takes, as input, an in-memory bot structure and generates Java code within the bot class. A utility classes generator 1120 can generate utility classes which are used by an entry class or bot class methods. The utility classes generator 1120 can generate, as output, Java classes. A data type generator 1122 can generate value types useful at runtime. The data type generator 1122 can generate, as output, Java classes. An expression generator 1124 can evaluate user inputs and generates compatible Java code, identifies complex variable mixed user inputs, inject variable values, and transform mathematical expressions. The expression generator 1124 can take, as input, user defined values and generates, as output, Java compatible expressions.

The JAR generator 1128 can compile Java source files, produces byte code and packs everything in a single JAR, including other child bots and file dependencies. The JAR generator 1128 can take, as input, generated Java files, resource files used during the bot creation, bot compiler dependencies, and command packages, and then can generate a JAR artifact as an output. The JAR cache manager 1130 can put a bot JAR in cache repository so that recompilation can be avoided if the bot has not been modified since the last cache entry. The JAR cache manager 1130 can take, as input, a bot JAR.

In one or more embodiment described herein command action logic can be implemented by commands 1001 available at the control room 808. This permits the execution environment on a device 810 and/or 815, such as exists in a user session 818, to be agnostic to changes in the command action logic implemented by a bot 804. In other words, the manner in which a command implemented by a bot 804 operates need not be visible to the execution environment in which a bot 804 operates. The execution environment is able to be independent of the command action logic of any commands implemented by bots 804. The result is that changes in any commands 1001 supported by the RPA system 800, or addition of new commands 1001 to the RPA system 800, do not require an update of the execution environment on devices 810, 815. This avoids what can be a time and resource intensive process in which addition of a new command 1001 or change to any command 1001 requires an update to the execution environment to each device 810, 815 employed in an RPA system. Take, for example, a bot that employs a command 1001 that logs into an on-online service. The command 1001 upon execution takes a Uniform Resource Locator (URL), opens (or selects) a browser, retrieves credentials corresponding to a user on behalf of whom the bot is logging in as, and enters the user credentials (e.g., username and password) as specified. If the command 1001 is changed, for example, to perform two-factor authentication, then it will require an additional resource (the second factor for authentication) and will perform additional actions beyond those performed by the original command (for example, logging into an email account to retrieve the second factor and entering the second factor). The command action logic will have changed as the bot is required to perform the additional changes. Any bot(s) that employ the changed command will need to be recompiled to generate a new bot JAR for each changed bot and the new bot JAR will need to be provided to a bot runner upon request by the bot runner. The execution environment on the device that is requesting the updated bot will not need to be updated as the command action logic of the changed command is reflected in the new bot JAR containing the byte code to be executed by the execution environment.

The embodiments herein can be implemented in the general context of computer-executable instructions, such as those included in program modules, being executed in a computing system on a target, real or virtual, processor. Generally, program modules include routines, programs, libraries, objects, classes, components, data structures, etc. that perform particular tasks or implement particular abstract data types. The program modules may be obtained from another computer system, such as via the Internet, by downloading the program modules from the other computer system for execution on one or more different computer systems. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may further include a device or product having content stored thereon at a time of sale or delivery. Thus, delivering a device with stored content, or offering content for download over a communication medium, may be understood as providing an article of manufacture with such content described herein.

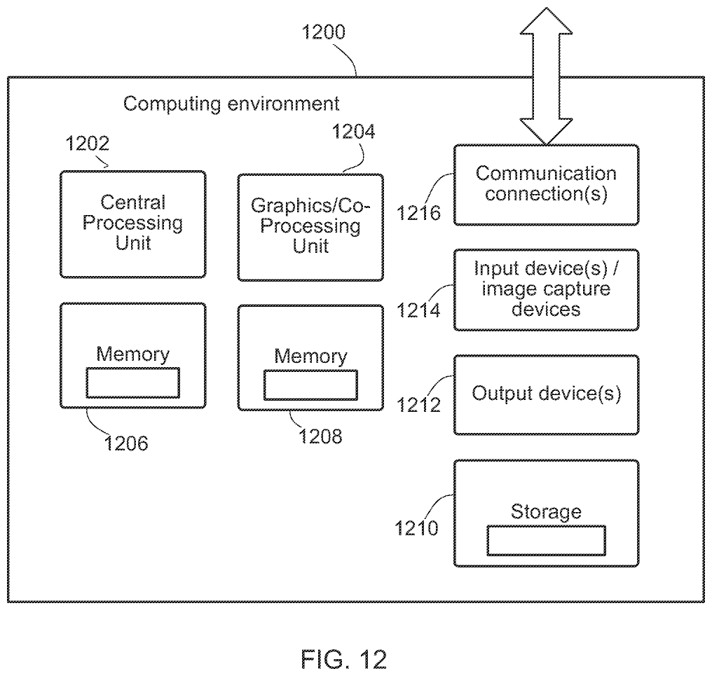

FIG. 12 illustrates a block diagram of an exemplary computing environment 1200 for an implementation of an RPA system, such as the RPA systems disclosed herein. The embodiments described herein may be implemented using the exemplary computing environment 1200. The exemplary computing environment 1200 includes one or more processing units 1202, 1204 and memory 1206, 1208. The processing units 1202, 1206 execute computer-executable instructions. Each of the processing units 1202, 1206 can be a general-purpose central processing unit (CPU), processor in an application-specific integrated circuit (ASIC) or any other type of processor. For example, as shown in FIG. 12, the processing unit 1202 can be a CPU, and the processing unit can be a graphics/co-processing unit (GPU). The tangible memory 1206, 1208 may be volatile memory (e.g., registers, cache, RAM), non-volatile memory (e.g., ROM, EEPROM, flash memory, etc.), or some combination of the two, accessible by the processing unit(s). The hardware components may be standard hardware components, or alternatively, some embodiments may employ specialized hardware components to further increase the operating efficiency and speed with which the RPA system operates. The various components of exemplary computing environment 1200 may be rearranged in various embodiments, and some embodiments may not require nor include all of the above components, while other embodiments may include additional components, such as specialized processors and additional memory.

The exemplary computing environment 1200 may have additional features such as, for example, tangible storage 1210, one or more input devices 1214, one or more output devices 1212, and one or more communication connections 1216. An interconnection mechanism (not shown) such as a bus, controller, or network can interconnect the various components of the exemplary computing environment 1200. Typically, operating system software (not shown) provides an operating system for other software executing in the exemplary computing environment 1200, and coordinates activities of the various components of the exemplary computing environment 1200.

The tangible storage 1210 may be removable or non-removable, and includes magnetic disks, magnetic tapes or cassettes, CD-ROMs, DVDs, or any other medium which can be used to store information in a non-transitory way, and which can be accessed within the computing system 1200. The tangible storage 1210 can store instructions for the software implementing one or more features of a PRA system as described herein.

The input device(s) or image capture device(s) 1214 may include, for example, one or more of a touch input device (such as a keyboard, mouse, pen, or trackball), a voice input device, a scanning device, an imaging sensor, touch surface, or any other device capable of providing input to the exemplary computing environment 1200. For multimedia embodiment, the input device(s) 1214 can, for example, include a camera, a video card, a TV tuner card, or similar device that accepts video input in analog or digital form, a microphone, an audio card, or a CD-ROM or CD-RW that reads audio/video samples into the exemplary computing environment 1200. The output device(s) 1212 can, for example, include a display, a printer, a speaker, a CD-writer, or any another device that provides output from the exemplary computing environment 1200.

The one or more communication connections 1216 can enable communication over a communication medium to another computing entity. The communication medium conveys information such as computer-executable instructions, audio or video input or output, or other data. The communication medium can include a wireless medium, a wired medium, or a combination thereof.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. In one embodiment, the computer readable medium is non-transitory. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method of executing a bot with automated resiliency, the method comprising:
identifying an action of the bot to be executed via a computing device having an associated display device, the action induces interaction with a particular portion of a graphical user interface (GUI) presented on the display device;
determining whether the particular portion of the GUI is accessible to the bot;
manipulating, when the particular portion of the GUI is determined to not be accessible to the bot, the manner by which at least a portion of the GUI is displayed on the display device so that the particular portion is accessible to the bot; and
performing the action with respect to the particular portion of the GUI.

2. A computer-implemented method as recited in claim 1,
wherein the GUI includes at least a first window,
wherein the particular portion is a point or area of the first window, and
wherein the determining whether the particular portion of the GUI is accessible to the bot comprises determining whether a second window is at least partially overlapping the particular portion of the first window.

3. A computer-implemented method as recited in claim 2, wherein the manipulating comprises:
causing the first window to be the top-most displayed window.

4. A computer-implemented method as recited in claim 2, wherein the manipulating comprises:
causing the second window to be minimized.

5. A computer-implemented method as recited in claim 2, wherein the manipulating comprises:
causing the second window to become a transparent window.

6. A computer-implemented method as recited in claim 1, wherein the determining whether the particular portion of the GUI is accessible to the bot comprises querying a Windows API for an active window at the particular portion.

7. A computer-implemented method as recited in claim 1,
wherein the particular portion is a particular position within the GUI, and
wherein the determining whether the particular portion of the GUI is accessible to the bot comprises querying a Windows API for an active window at the particular position.

8. A computer-implemented method as recited in claim 1,
wherein the particular portion is a particular area within the GUI, and
wherein the determining whether the particular portion of the GUI is accessible to the bot comprises:
identifying a plurality of particular points that are within the particular area; and
querying a Windows API for an active window at the plurality of particular points.

9. A computer-implemented method as recited in claim 1, wherein the GUI pertains to an application program, and wherein when the particular portion of the GUI is determined to not be accessible to the bot, the GUI is at least partially obstructed.

10. A computer-implemented method as recited in claim 9, wherein when the particular portion of the GUI is determined to not be accessible to the bot, the particular portion of the GUI is at least partially obstructed by a pop-up window.

11. A computer-implemented method of executing a bot with resiliency, the method comprising:
identifying an action of the bot to be executed via a computing device having an associated display device, the action induces interaction with a particular portion of an application window presented on the display device;
determining whether an unexpected pop-up window is present over the particular portion of the application window that the action of the bot is to interact with;
modifying, when the determining determines that an unexpected pop-up window is present over the particular portion of the application window that the action of the bot is to interact with, presentation on the display device of the pop-up window or the application window so that the pop-up window is no longer present over the particular portion of the application window that the action of the bot is to interact with; and
executing the action of the bot by inducing interaction with the particular portion of the application window presented on the display device.

12. A computer-implemented method as recited in claim 11,
wherein the particular portion is a particular position within the application window, and
wherein the determining whether an unexpected pop-up window is present over the particular portion of the application window that the action of the bot is to interact with comprises:
querying a Windows API for an active window at the particular position;
evaluating whether the active window is the application window; and
determining that an unexpected pop-up window is present over the particular portion of the application window that the action of the bot is to interact when the evaluating indicates that the active window is not the application window.

13. A computer-implemented method as recited in claim 11,
wherein the particular portion is a particular area within the application window, and
wherein the determining whether an unexpected pop-up window is present over the particular portion of the application window that the action of the bot is to interact with comprises:
identifying a plurality of particular points that are within the particular area;
querying a Windows API for an active window at each of the plurality of particular points; and
comparing whether the active window is the application window at each of the plurality of particular points; and
determining that an unexpected pop-up window is present over the particular portion of the application window that the action of the bot is to interact when the comparing indicates that the active window is not the application window at each of the plurality of particular points.

14. A computer-implemented method of executing a bot, the method comprising:
identifying an action of the bot to be executed via a computing device having an associated display device;
determining whether the action requires a graphical user interface (GUI) to be presented on the display device and accessible to the bot;
identifying a portion of the GUI that the action requires be accessible to the bot;
determining whether the portion of the GUI is presently accessible to the bot;
manipulating, when the determining determines that the portion is not presently accessible to the bot, the manner by which the GUI is displayed on the display device so that the portion of the GUI becomes accessible to the bot; and
subsequently performing the action with respect to the GUI.

15. A computer-implemented method as recited in claim 14 wherein the GUI includes at least an application program window, wherein the particular portion corresponds to a point or area of the application program window, and wherein when the particular portion of the GUI is determined to not be accessible to the bot, the point or area of the application program window is at least partially obstructed.

16. A computer-implemented method as recited in claim 15, wherein when the particular portion of the GUI is determined to not be accessible to the bot, the point or area of the application program window is at least partially obstructed by an unexpected pop-up window.

17. A non-transitory computer readable medium including at least computer program code tangibly stored thereon for executing a software robot, the computer program code comprising:
computer program code for identifying an action of the software robot to be executed via a computing device having an associated display device, the action induces interaction with a particular portion of a graphical user interface (GUI) presented on the display device;
computer program code for determining whether the particular portion of the GUI is accessible to the software robot;
computer program code for manipulating, when the particular portion of the GUI is determined to not be accessible to the software robot, the manner by which at least a portion of the GUI is displayed on the display device so that the particular portion is accessible to the software robot; and
computer program code for performing the action with respect to the particular portion of the GUI.

18. A non-transitory computer readable medium as recited in claim 17, wherein the computer program code for manipulating comprises:
computer program for moving the at least a portion of the GUI to a top-most layer of the GUI displayed in the display device.

19. A non-transitory computer readable medium as recited in claim 17, wherein the computer program code for manipulating comprises:
computer program for minimizing the at least a portion of the GUI displayed in the display device.

20. A non-transitory computer readable medium as recited in claim 17, wherein the computer program code for manipulating comprises:
computer program for rendering transparent the at least a portion of the GUI displayed in the display device.

21. A non-transitory computer readable medium as recited in claim 17, wherein the GUI pertains to an application program, and wherein when the particular portion of the GUI is determined to not be accessible to the software robot, the GUI is at least partially obstructed.

22. A non-transitory computer readable medium as recited in claim 17, wherein the GUI includes at least one application window, and wherein the particular portion of the GUI is at least partially obstructed by an unexpected pop-up window when the particular portion of the GUI is determined to not be accessible to the software robot.

23. A non-transitory computer readable medium as recited in claim 22, wherein the computer program code for manipulating comprises:
computer program for moving the at least a portion of the GUI to a top-most layer of the GUI displayed in the display device; and
computer program for minimizing the at least a portion of the GUI displayed in the display device.

24. A non-transitory computer readable medium as recited in claim 23, wherein the computer program code for manipulating comprises:
computer program for rendering transparent the at least a portion of the GUI displayed in the display device.

25. A non-transitory computer readable medium as recited in claim 23,
wherein the at least a portion of the GUI being moved to a top-most layer of the GUI displayed in the display device is a window, and
wherein the at least a portion of the GUI displayed in the display device being minimized is a window.

26. A non-transitory computer readable medium as recited in claim 17, wherein the GUI includes at least an application program window, wherein the particular portion of the GUI corresponds to a point or area of the application program window, and wherein when the particular portion of the GUI is determined to not be accessible to the software robot, the point or area of the application program window is at least partially obstructed.

27. A non-transitory computer readable medium as recited in claim 26, wherein when the particular portion of the GUI is determined to not be accessible to the software robot, the point or area of the application program window is at least partially obstructed by an unexpected pop-up window.
